(19) United States
(12) Patent Application Publication
(10) Pub. No.: US 2004/0136504 A1
(43) Pub. Date: Jul. 15, 2004

(54) Call recording system with multiple call data access options

(75) Inventor: Chun-I Wu, Tainan County (TW)

Correspondence Address: WEBB ZIESENHEIM LOGSDON ORKIN, & HANSON P.C., 700 Koppers Building, 436 Seventh Avenue, Pittsburgh, PA, 15219-1818, US

(73) Assignee: OCTTEL COMMUNICATION CO., LTD.

(21) Appl. No.: 10/744,665

(22) Filed: Dec. 23, 2003

(30) Foreign Application Priority Data
Dec. 27, 2002 (TW) 091137715

(51) Int. Cl. H04M 1/64; H04M 11/00

(52) U.S. Cl. 379/67.1; 379/88.13; 379/387.01

(57) ABSTRACT

A call recording system includes a processing module operable in a call recording mode for storing compressed call data in a data storage device. The processing module is further operable in a selected one of a near data access mode, where call data retrieval is conducted under the control of a telephone handset connected to the system, a remote data access mode, where call data retrieval is conducted under the control of a remote terminal connected to the system via a telephone network, and a computer network access mode, where call data retrieval is conducted through a computer network connection with the system.

### CROSS-REFERENCE TO RELATED APPLICATION

This application claims priority of Taiwanese application no. 091137715, filed on Dec. 27, 2002.

### BACKGROUND OF THE INVENTION

1. Field of the Invention

The present invention relates to a call recording system, more particularly to a call recording system with multiple call data access options.

2. Description of the Related Art

Call recording systems are in wide use nowadays. In some applications, multiple voice channels are available for simultaneous recording of telephone calls. Access of recorded call data is possible through direct operation of the call recording system and, in some instances, through the control of a remote terminal that is connected to the call recording system via a telephone network. It is desirable to provide a call recording system with a greater number of call data access options for enhanced system functionality.

### SUMMARY OF THE INVENTION

Accordingly, the present invention provides a call recording system that comprises a telephone network interface unit, a telephone handset interface unit, a computer network interface unit, a signal conversion module, a processing module, and a data storage device.

The telephone network interface unit is adapted for connection to a telephone line. The telephone handset interface unit is adapted for connection to a telephone handset. The computer network interface unit is adapted for connection to a computer network. The signal conversion module is coupled to the telephone network interface unit, the telephone handset interface unit, and the computer network interface unit, and includes an analog-to-digital signal converter and a digital-to-analog signal converter. The processing module is coupled to the computer network interface unit and the signal conversion module, and includes a data compression unit and a data decompression unit. The data storage device is coupled to the processing module.

The processing module is operable in a call recording mode, where an analog call signal received through the telephone network interface unit is converted into a digital call signal by the analog-to-digital signal converter of the signal conversion module under control of the processing module, where the digital call signal is compressed by the data compression unit of the processing module to result in digital call data, and where the digital call data is stored by the processing module in the data storage device.

The processing module is further operable in a selected one of a near data access mode, a remote data access mode, and a computer network access mode.

Operation of the processing module in the near data access mode is initiated through control of the telephone handset connected to the telephone handset interface unit, and involves: retrieving of the digital call data stored in the data storage device, and decompressing of the digital call data through the data decompression unit of the processing module to result in the digital call signal; and conversion of the digital call signal into the analog call signal through the digital-to-analog signal converter of the signal conversion module, and transmission of the analog call signal to the telephone handset interface unit for reception by the telephone handset under control of the processing module.

Operation of the processing module in the remote data access mode is initiated through an incoming access control signal received by the processing module through the telephone network interface unit, and involves: retrieving of the digital call data stored in the data storage device, and decompressing of the digital call data through the data decompression unit of the processing module to result in the digital call signal; and conversion of the digital call signal into the analog call signal through the digital-to-analog signal converter of the signal conversion module, and transmission of the analog call signal to the telephone network interface unit under control of the processing module.

Operation of the processing module in the computer network access mode is initiated through an incoming network control signal received by the processing module through the computer network interface unit, and involves retrieving of the digital call data stored in the data storage device, and transmission of the digital call data to the computer network interface unit.

### BRIEF DESCRIPTION OF THE DRAWING

Other features and advantages of the present invention will become apparent in the following detailed description of the preferred embodiment with reference to the accompanying drawing, of which:

FIG. 1 is a schematic block diagram of the preferred embodiment of a call recording system according to the present invention.

### DETAILED DESCRIPTION OF THE PREFERRED EMBODIMENT

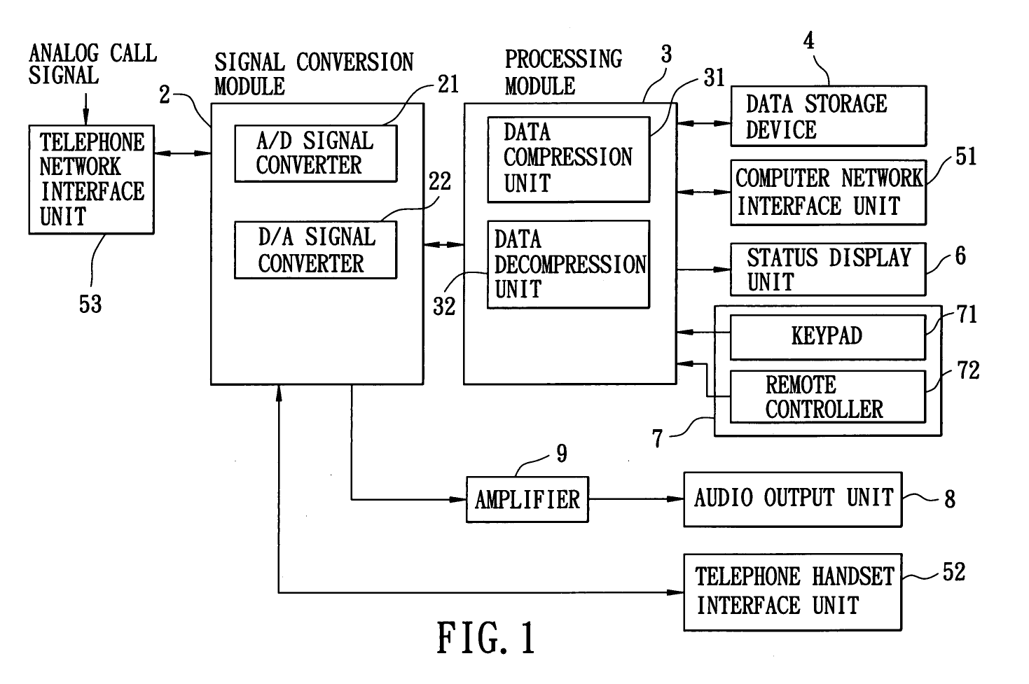

FIG. 1 is a block diagram of the preferred embodiment of a call recording system 1 according to the present invention. The call recording system 1 includes a telephone network interface unit 53, a telephone handset interface unit 52, a computer network interface unit 51, a signal conversion module 2, a processing module 3, a data storage device 4, a status display unit 6, a user input device 7, an audio output unit 8, and an amplifier 9.

The telephone network interface unit 53 is adapted for connection to at least one telephone line. In this embodiment, the telephone network interface unit 53 includes known high-impedance circuits and RJ-11 connector ports for connection to a public telephone network (PTN) or a private branch exchange (PBX). Preferably, the telephone network interface unit 53 permits connection of the call recording system 1 to four or eight telephone lines, thereby providing four or eight voice channels for simultaneous processing of telephone calls. The high-impedance circuits of the telephone network interface unit 53 ensure call signal quality and permit detection of incoming and outgoing telephone calls in a conventional manner. The telephone handset interface unit 52 is adapted for connection to a telephone handset. In this embodiment, the telephone handset interface unit 52 includes an RJ-11 connector port. The computer network interface unit 51 is adapted for connection to a computer network. In this embodiment, the computer network is an Ethernet computer network. The signal conversion module 2 is coupled to the telephone network interface unit 53, the telephone handset interface unit 52, and the computer network interface unit 51, and includes an analog-to-digital (A/D) signal converter 21 and a digital-to-analog (D/A) signal converter 22. The processing module 3 is coupled to the computer network interface unit 51 and the signal conversion module 2, and includes a data compression unit 31 and a data decompression unit 32. In this embodiment, the processing module 3 is implemented using a digital signal processor, such as one with Serial No. AC48304C, and an embedded-type central processing unit, such as one with Serial No. 386SX. Preferably, either ITU-T G.723.1 MP-MLQ 6.3 Kbps or ITU-T G.729A CS-ACELP 8.0 Kbps is adopted as the compression format. If the aforesaid ITU-T G.723.1 MP-MLQ 6.3 Kbps is adopted, a 40-gigabyte hard disk can be used to store up to 13,000 hours of voice data. The data storage device 4 is coupled to the processing module 3, and includes one of a hard disk, an optical storage medium (such as a DVD-RAM), and a magnetic tape. In this embodiment, the data storage device 4 is a 40-gigabyte hard disk. The user input device 7 is coupled to the processing module 3. In this embodiment, the user input device 7 includes at least one of a keypad 71 and a known infrared remote controller 72. The audio output unit 8 is coupled to the signal conversion module 2. Preferably, the audio output unit 8 is one of a built-in speaker and a connector adapted for connecting with an external audio reproduction device, such as an earphone. The amplifier 9 is coupled to and is disposed between the audio output unit 8 and the signal conversion module 2. In this embodiment, the status display unit 6 includes a liquid crystal display coupled to and controlled by the processing module 3 for indicating operating status of the processing module 3.

The processing module 3 is operable in a call recording mode, where an analog call signal received through the telephone network interface unit 53 is converted into a digital call signal by the A/D signal converter 21 of the signal conversion module 2 under control of the processing module 3, where the digital call signal is compressed by the data compression unit 31 of the processing module 3 to result in digital call data, and where the digital call data is stored by the processing module 3 in the data storage device 4.

The processing module 3 is further operable in a selected one of a near data access mode, a remote data access mode, a computer network access mode, and a direct data access mode. In this embodiment, the processing module 3 is further configured with an interactive voice response system (IVR) for guiding data access during operation in the near data access mode and the remote data access mode.

Operation of the processing module 3 in the near data access mode is initiated through control of the telephone handset connected to the telephone handset interface unit 52. To access data, the user must first pick up the telephone handset and enter his password. After verifying the identity of the user, the IVR of the processing module 3 guides the user in the near data access mode to select recorded call data according to desired criteria, such as call time, record number, caller ID, etc. The near data access mode involves retrieving of the selected digital call data stored in the data storage device 4 and decompressing of the selected digital call data through the data decompression unit 32 of the processing module 3 to result in the digital call signal, and conversion of the digital call signal into the analog call signal through the D/A signal converter 22 of the signal conversion module 2 and transmission of the analog call signal to the telephone handset interface unit 52 for reception by the telephone handset under the control of the processing module 3.

Operation of the processing module 3 in the remote data access mode is initiated through an incoming access control signal received by the processing module 3 through the telephone network interface unit 53. To access data, the user must first establish a telephone network connection (such as a PSTN connection or a PBX connection) with the call recording system 1. When the telephone network connection is established, the user enters his password and, after verifying the identity of the user, the IVR of the processing module 3 guides the user in the remote data access mode to select recorded call data according to desired criteria, such as call time, record number, caller ID, etc. The remote data access mode involves retrieving of the digital call data stored in the data storage device 4 and decompressing of the digital call data through the data decompression unit 32 of the processing module 3 to result in the digital call signal, and conversion of the digital call signal into the analog call signal through the D/A signal converter 22 of the signal conversion module 2 and transmission of the analog call signal to the telephone network interface unit 53 under the control of the processing module 3.

Operation of the processing module 3 in the computer network access mode is initiated through an incoming network control signal received by the processing module 3 through the computer network interface unit 51, and involves retrieving of selected digital call data stored in the data storage device 4 and transmission of the selected digital call data to the computer network interface unit 51. Due to the connection with the Ethernet computer network, call record management and back-up of recorded call data using a remote data storage device, such as a hard disk, a magnetic tape or a DVD-RAM, are possible in the call recording system 1 of the present invention.

Operation of the processing module 3 in the direct data access mode is initiated under the control of the keypad 71 or the remote controller 72 of the user input device 7, and involves retrieving of selected digital call data stored in the data storage device 4 and decompressing of the selected digital call data through the data decompression unit 32 of the processing module 3 to result in the digital call signal, and conversion of the digital call signal into the analog call signal through the D/A signal converter 22 of the signal conversion module 2 and transmission of the analog call signal to the audio output unit 8 under the control of the processing module 3.

Preferably, the processing module 3 is further responsive to at least one of the user input device 7, the telephone handset, and the incoming access control signal for selective operation in a real-time call monitoring mode, where selected digital call signal received by the processing module 3 from the A/D signal converter 21 of the signal conversion module 2 is converted back into the analog call signal by the D/A signal converter 22 of the signal conversion module 2 under the control of the processing module 3, and is transmitted to a corresponding one of the audio output unit 8, the telephone handset interface unit 52, and the telephone network interface unit 53.

It is apparent from the foregoing that the call recording system 1 of this invention provides different call access options to meet various user requirements. Moreover, the call recording system 1 of this invention is relatively easy to operate and maintain, is cost-effective, and is ideal for use by small businesses and enterprises.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A call recording system comprising:
a telephone network interface unit adapted for connection to a telephone line;
a telephone handset interface unit adapted for connection to a telephone handset;
a computer network interface unit adapted for connection to a computer network;
a signal conversion module coupled to said telephone network interface unit, said telephone handset interface unit, and said computer network interface unit, said signal conversion module including an analog-to-digital signal converter and a digital-to-analog signal converter;
a processing module coupled to said computer network interface unit and said signal conversion module, and including a data compression unit and a data decompression unit; and
a data storage device coupled to said processing module;
said processing module being operable in a call recording mode, where an analog call signal received through said telephone network interface unit is converted into a digital call signal by said analog-to-digital signal converter of said signal conversion module under control of said processing module, where the digital call signal is compressed by said data compression unit of said processing module to result in digital call data, and where the digital call data is stored by said processing module in said data storage device;
said processing module being further operable in a selected one of a near data access mode, a remote data access mode, and a computer network access mode;
wherein operation of said processing module in the near data access mode is initiated through control of the telephone handset connected to said telephone handset interface unit, and involves
retrieving of the digital call data stored in said data storage device, and decompressing of the digital call data through said data decompression unit of said processing module to result in the digital call signal, and
conversion of the digital call signal into the analog call signal through said digital-to-analog signal converter of said signal conversion module, and transmission of the analog call signal to said telephone handset interface unit for reception by the telephone handset under control of said processing module;
wherein operation of said processing module in the remote data access mode is initiated through an incoming access control signal received by said processing module through said telephone network interface unit, and involves
retrieving of the digital call data stored in said data storage device, and decompressing of the digital call data through said data decompression unit of said processing module to result in the digital call signal, and
conversion of the digital call signal into the analog call signal through said digital-to-analog signal converter of said signal conversion module, and transmission of the analog call signal to said telephone network interface unit under control of said processing module;
wherein operation of said processing module in the computer network access mode is initiated through an incoming network control signal received by said processing module through said computer network interface unit, and involves retrieving of the digital call data stored in said data storage device, and transmission of the digital call data to said computer network interface unit.

2. The call recording system as claimed in claim 1, further comprising:
a user input device coupled to said processing module; and
an audio output unit coupled to said signal conversion module;
said processing module being further operable selectively in a direct data access mode, wherein operation of said processing module in the direct data access mode is initiated under control of said user input device and involves
retrieving of the digital call data stored in said data storage device, and decompressing of the digital call data through said data decompression unit of said processing module to result in the digital call signal, and
conversion of the digital call signal into the analog call signal through said digital-to-analog signal converter of said signal conversion module, and transmission of the analog call signal to said audio output unit under control of said processing module.

3. The call recording system as claimed in claim 2, wherein said processing module is further responsive to at least one of said user input device, the telephone handset, and the incoming access control signal for selective operation in a real-time call monitoring mode, where the digital call signal received by said processing module from said analog-to-digital signal converter of said signal conversion module is converted back into the analog call signal by said digital-to-analog signal converter of said signal conversion module under control of said processing module, and is transmitted to a corresponding one of said audio output unit, said telephone handset interface unit, and said telephone network interface unit.

4. The call recording system as claimed in claim 1, wherein said processing module is further responsive to at least one of the telephone handset and the incoming access control signal for selective operation in a real-time call monitoring mode, where the digital call signal received by said processing module from said analog-to-digital signal converter of said signal conversion module is converted back into the analog call signal by said digital-to-analog signal converter of said signal conversion module under control of said processing module, and is transmitted to a corresponding one of said telephone handset interface unit and said telephone network interface unit.

5. The call recording system as claimed in claim 1, wherein said computer network interface unit is adapted for connection to an Ethernet computer network.

6. The call recording system as claimed in claim 1, wherein said data storage device is one of a hard disk, an optical storage medium, and a magnetic tape.

7. The call recording system as claimed in claim 2, wherein said user input device includes a keypad.

8. The call recording system as claimed in claim 2, wherein said user input device includes a remote controller.

9. The call recording system as claimed in claim 2, wherein said audio output unit includes a speaker.

10. The call recording system as claimed in claim 2, wherein said audio output unit includes a connector adapted for connecting with an external audio reproduction device.

11. The call recording system as claimed in claim 2, further comprising an amplifier coupled to and disposed between said audio output unit and said signal conversion module.

12. The call recording system as claimed in claim 1, further comprising a status display unit coupled to and controlled by said processing module for indicating operating status of said processing module.

13. The call recording system as claimed in claim 1, wherein said processing module is configured with an interactive voice response system for guiding data access during operation in at least one of the near data access mode and the remote data access mode.
